(19) United States
(12) Patent Application Publication
(10) Pub. No.: US 2010/0002223 A1
(43) Pub. Date: Jan. 7, 2010

(54) EXTERNAL MICROCONTROLLER FOR LED LIGHTING FIXTURE, LED LIGHTING FIXTURE WITH INTERNAL CONTROLLER, AND LED LIGHTING SYSTEM

(75) Inventors: Cristian Presura, Veldhoven (NL); Gary Nelson Garcia Molina, Eindhoven (NL); Markus Laubscher, Eindhoven (NL); Gerhardus Wilhelmus Lucassen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/513,921

(22) PCT Filed: Nov. 13, 2007
(86) PCT No.: PCT/IB07/54622

§ 371 Date: May 7, 2009

(51) Int. Cl. G01C 3/08; G01P 3/36

(52) U.S. Cl. 356/4.01; 356/28

(57) ABSTRACT

A detector (210, 310) that is configured to detect ghost-coherent reflections (260) produced by a superluminescent diode (SLD). The ghost reflections (260) are detected based on the optical coherence produced by reflections from surfaces (350, 450, 555) that are at integer multiples of the reflections within the SLD cavity (213), and thus exhibit the fine resolution discrimination that is typical of optical coherent detectors. In a preferred embodiment, the detector (210, 310) is configured to detect ghost reflections (260) from a surface at a particular multiple of the internal reflections. Ghost reflections (260) at other multiples are optically attenuated (330), or, if such reflections are known to be non-varying, canceled via a calibration procedure.

This invention relates to the field of optical sensors, and in particular to a optical detector that provides coherent detection without the use of an external beamsplitter.

Optical detectors are commonly used to measure distance by projecting light to a surface and detecting the reflections. Typically, a laser diode projects the light, and the reflected light introduces a detectable interference pattern. The distance between the source and the reflecting object determines when the interference occurs. If reflections may be generated from multiple surfaces, or from multiple layers of translucent materials, lens systems are used to efficiently gather the reflections from a focal point in preference to other reflections.

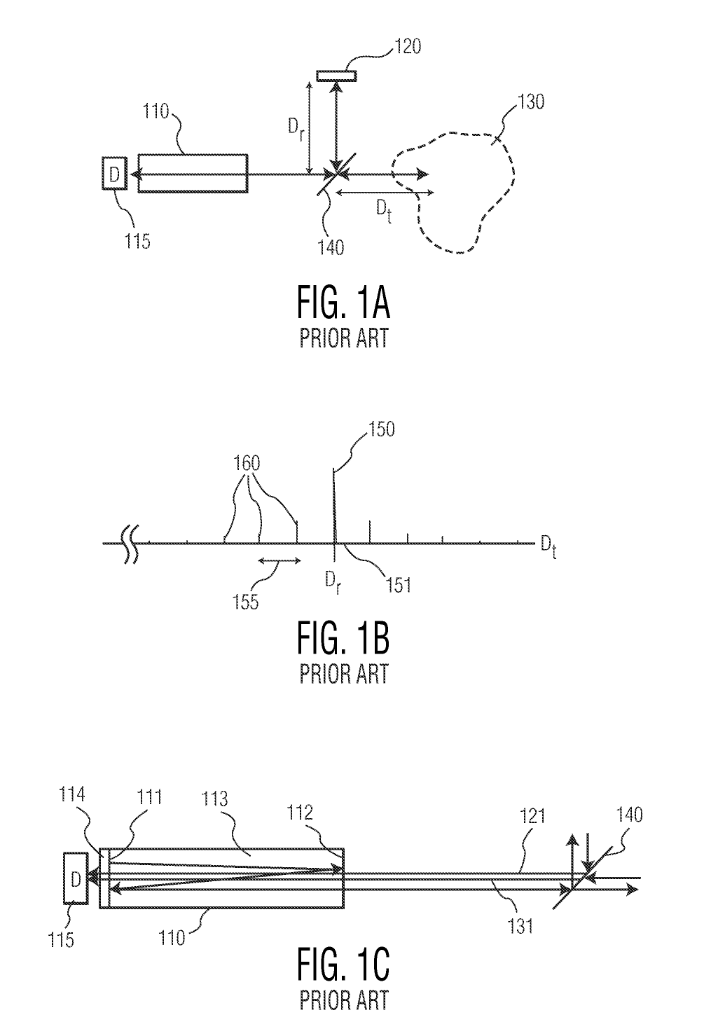

Optical Coherent Tomography (OCT) technology provides for high resolution optical detection and imagery. FIG. 1A illustrates an example configuration of an optical coherent detector that uses an external mirror to provide a reference reflection. As in conventional optical detectors, a light beam is projected from a laser device 110, typically a Superluminescent Laser Diode (SLD) device, directed to a target object 130, and the reflections from the object are detected by a detector 115. In a coherent detector, two reflections are obtained from the light beam, a reference reflection and a target reflection. If the reference reflection and target reflection are coherent, the detectable reflection is substantially greater than the reflection produced by non-coherent reflections.

As illustrated in FIG. 1A, the example coherent detector uses a beamsplitter 140 to split the projected beam. One of the split beams (hereinafter the referencing beam) is directed to a mirror 120, and reflected back to the source; the other split beam (hereinafter the targeting beam) is directed away from the source toward a target 130. If reflections of the targeting beam from the target 130 arrive at the source at the same time as the reflections of the referencing beam from the mirror 120, they will be coherent. That is, if the distance from the source to the target surface 130 is equal to the distance from the source to the reference surface 120, a coherent reflection will occur and produce a high amplitude detection signal; otherwise, the reflections will be non-coherent and produce a low amplitude detection signal. Alternatively stated, reflections from target surfaces at the reference distance (Dₜ=Dᵣ) from the source will provide a high detection amplitude while reflections from surfaces at different distances (D_{t≠D}ᵣ) will provide a low detection amplitude. By changing the reference distance Dᵣ, target surfaces at different distances (Dₜ=Dᵣ) can be detected. By varying the reference distance Dᵣ over time, a depth-profile of a translucent material, such as body tissue, can be obtained, the characteristics of the tissue material at different layers providing different reflective intensities.

FIG. 1B illustrates the amplitude of the detected reflections as a function of the distance Dₜ of the target reflecting surface from the laser source 114. As illustrated, if the target reflecting surface is at a distance Dₜ=Dᵣ from the source, the signal 150 detected by the detector 115 of FIG. 1A will be substantial. The precision, or resolution, of the detection is very high, because reflections from a surface at a distance 151 slightly different from Dᵣ will be minimal. Resolution in the order of micrometers is commonly achievable using coherent detection, much finer that a typical interference based system. This fine precision allows for the aforementioned depth-profiling by distinguishing reflections at the reference distance Dᵣ as the reference distance Dᵣ is varied.

As illustrated in FIG. 1B, the distinguishing capability of a conventional coherent detector is flawed by ‘ghost reflections’ 160. Reflections from surfaces at certain locations different from Dᵣ also produce a discernible output 160 from the detector 115. These ghost reflection outputs 160 will distort the measure of the desired target output 150, and are generally attenuated by limiting the depth of field of the optical system that is focused at the target distance Dᵣ to exclude/attenuate reflections from surfaces beyond this depth from the target distance Dᵣ. These ghost reflections 160 are caused by reflections that are coherent with other components of the projected light beam, as detailed below.

FIG. 1C illustrates a typical superluminescent diode (SLD) device 110 with a chamber cavity 1 13. Within this chamber 113, a rear surface 111 is near-totally reflective (>>99%), and a front surface 112 is only slightly reflective (<1%). The physical structure of the chamber 113 and the degrees of relectivity within the chamber 113 will determine the average number of reflections within the chamber 113, as well as the variance about this average. The ghost reflections 160 correspond to reflections 131 from the target 130 that are coherent with rays corresponding to those at variance from the average/predominant rays 121 that are reflected from the reference reflector 120. Because the physical structure causes the ghost-coherent rays, the ghost reflections 160 occur at fixed intervals 155, dependent upon the size of the chamber 113. Conventional SLDs exhibit ghost reflections 160 at intervals of about 1-2 millimeters, and the optical systems are configured to have a depth of field of less than a millimeter to avoid these ghost reflections 160.

The example optical coherent detector of FIG. 1A provides very fine resolution, but requires a fixture to support the beamsplitter 140 and reference reflector 120 in a stable position relative to the source 110.

It would be advantageous to provide an optical coherent detector that did not require a fixture to support the beamsplitter and reference reflector in a stable position relative to the source. It would also be advantageous to provide an optical coherent detector that did not require a beamsplitter. It would also be advantageous to provide an optical coherent detector that did not require an external reference reflector.

These advantages, and others, can be realized by a detector that is designed to detect ghost reflections produced by a superluminescent diode (SLD). The ghost reflections are detected based on the optical coherence produced by reflections from surfaces that are at integer multiples of the reflections within the SLD cavity, and thus exhibit the fine resolution discrimination that is typical of optical coherent detectors. In a preferred embodiment, the detector is configured to detect ghost reflections from a surface at a particular multiple of the internal reflections. Ghost reflections at other multiples are optically attenuated, or, if such reflections are known to be non-varying, canceled via a calibration procedure.

The invention is explained in further detail, and by way of example, with reference to the accompanying drawings wherein:

FIGS. 1A-1C illustrate an example prior art optical coherent detector.

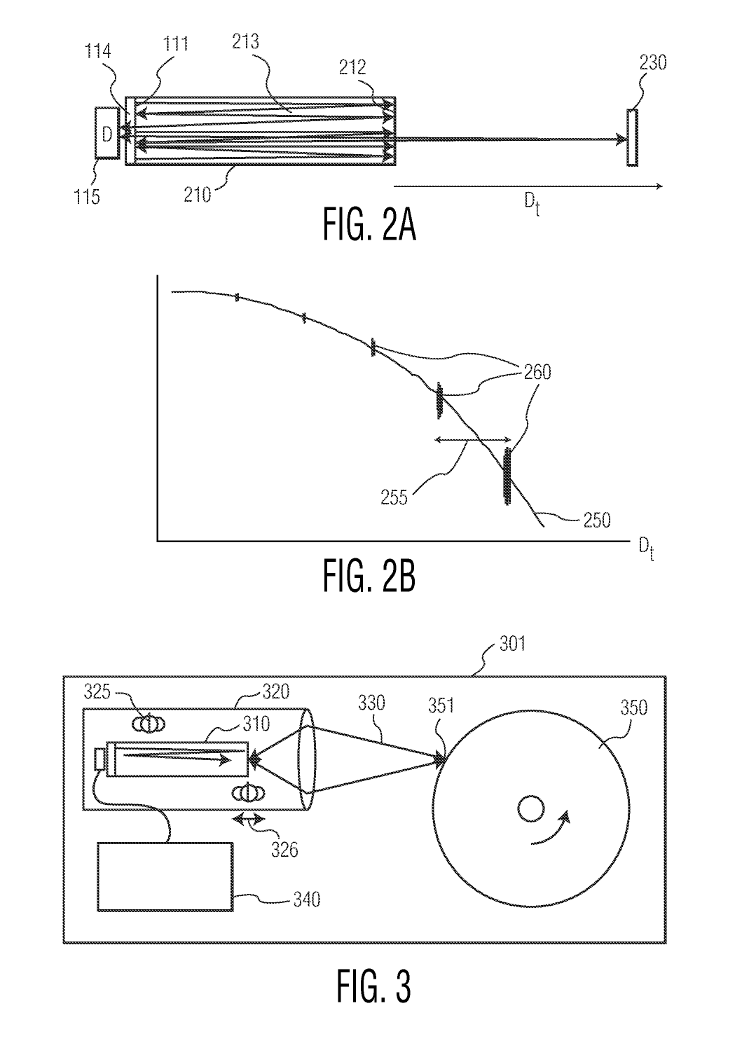

FIGS. 2A-2B illustrate a superluminescent diode in accordance with this invention.

FIGS. 3-5 illustrate example applications of an optical detector configuration in accordance with this invention.

Throughout the drawings, the same reference numeral refers to the same element, or an element that performs substantially the same function. The drawings are included for illustrative purposes and are not intended to limit the scope of the invention.

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. For purposes of simplicity and clarity, detailed descriptions of well-known devices, circuits, and methods are omitted so as not to obscure the description of the present invention with unnecessary detail.

This invention is premised on the observation that coherent reflections occur within a superluminescent diode device at integer multiples of the reflections produced within the cavity of the diode device. Conventionally, these reflections, termed ghost reflections, are undesirable artifacts produced by the structure required to provide the superluminescent light output, and care is taken to avoid or minimize these reflections. Conversely, in this invention, these reflections are not avoided, and are preferably enhanced.

FIG. 2A illustrates a superluminescent diode device (SLD) 210 that is configured to enhance the reflections within the cavity 213 of the device, thereby enhancing the occurrence of ghost reflections. Although the principles of this invention can be applied to a conventional SLDs, and enhancement of the ghost reflections is not required, per se, such enhancement eases the subsequent detection process by providing a higher amplitude coherent signal.

As noted above with regard to FIG. 1C, a conventional SLD 110 includes a highly reflective rear surface 111, and an anti-reflective front surface 112. Preferably, the conventional SLD 110 is configured to produce as few reflections as required to produce the desired superluminescent output. If the reflectivity of the front surface 112 is increased, the occurrence and intensity of ghost reflections is increased. If the reflectivity of the front surface 112 is increased beyond a certain threshold, the device operates as a conventional laser device.

The SLD 210 is preferably configured to provide as many internal reflections as possible without causing laser emissions. That is, for example, if the threshold reflectivity for inducing laser operation is Rₗₐₛₑᵣ, the front surface 212 of the SLD 210 may be configured to provide a reflectivity of 0.9*Rₗₐₛₑᵣ, thereby causing many reflections within the cavity of the SLD 210, but without causing the SLD 210 to enter a laser emission state.

FIG. 2B illustrates an example plot of the output of the optical detector 115 of the SLD 210 as a function of the distance that a reflecting surface is placed from the SLD 210. In this example, the SLD 210 is configured to provide a modulated light output, and a reflecting surface is placed at continually greater distances Dₜ from the SLD 210. As the general shape 250 of the curve indicates, the detected reflections diminish inversely to the square of the distance from the source. However, at certain distances 260 from the SLD 210, the reflections are coherent with the reflections within the SLD 210, and the modulations of the light are clearly discernible. That is, the optical ‘gain’ of the SLD 210 exhibits peaks 260 at regular intervals 255 of distance from the SLD 210.

Conceptually, the front surface 212 provides a plurality of ‘reference reflections’ just as the reference mirror 120 provides a reference reflection in the conventional optical coherent detector of FIG. 1A. At each specific distance 260 from the SLD 210, the target reflections are coherent with a subset of the reference reflections provided by the front surface 212, and the coherent combination provides a substantially higher amplitude output from the detector 115 than reflections that are not coherent with any of the reference reflections. Because these higher-gain peaks are the result of optical coherence, a slight offset from each coherent distance 260 results in a substantial decrease in the output of the detector 115, thereby providing a high degree of discrimination/resolution in the vicinity of each peak-providing distance 260. That is, at each peak 260, optical coherent detection occurs, without the use of an external beamsplitter and reference mirror. The surface 212 can be considered to correspond to the reference mirror of a conventional coherent detector, and each reflection within the cavity of the SLD 210 can be considered to correspond to a reference beam that a conventional beamsplitter provides.

FIGS. 3-5 illustrate example uses of an SLD device for optical coherent detection without the use of an external reference mirror or beamsplitter.

In FIG. 3, an SLD detector 310 is used to detect a velocity of a rotating object 350. The SLD detector 310 is mounted on a fixture 320 that is affixed on a supporting structure 301 at a particular distance from a point 351 the surface of the rotating object 350. The distance to the point 351 is selected to be at one of the ghost-resonance distances 260 relative to the detector 310 as illustrated in FIG. 2B so that the reflections from the point 351 are resonant with light beams that are reflected within the detector 310. Optionally, adjustment means 325 are provided to align detector 310 at the appropriate distance from the point 351 during a calibration process. Although a simple slide adjustment is illustrated, any of many conventional adjustment techniques for providing micrometer-scale adjustments may be used.

A processor 340 receives the output of the detector 310 and provides any of a variety of conventional measures based on this output, including, but not limited to those disclosed in U.S. Pat. No. 6,618,128, “OPTICAL SPEED SENSING SYSTEM”, issued 9 Sep. 2003 to Van Voorhis et al., and incorporated by reference herein. Van Voorhis et al. teach a technique for measuring rotation speed by detecting repeated surface reflection patterns. Other techniques, based on Doppler effects are also commonly used. By using the self coherent optical detection of the current invention, these known techniques for measuring the speed of a moving object/surface can be enhanced by providing high-resolution coherent detection, but without the cost and complexity of conventional coherent detection systems that use external reflectors and beamsplitters.

In a preferred embodiment, a lens system 330 is also used to distinguish/focus the projection to and reflections from the target surface. The lens system 330 provides a focal point that corresponds to the point 351 at the target ghost-coherent distance 260. However, as contrast to conventional non-coherent detectors, the lens system 330 need not have as fine a resolution, because it need only distinguish the reflections of the target surface from reflections at other, non-target, ghost-coherent distances. That is, with reference to FIG. 2B, if the spacing 255 between the ghost-coherent distances 260 is in the order of one millimeter, a lens system 330 with an effective depth of field of less than two millimeters will be sufficient to substantially diminish the non-target ghost-coherent reflections. In this example, even though the optical lens system may only provide a resolution in the order of millimeters, the ghost-coherent detection process taught herein will provide an effective resolution in the order of micrometers.

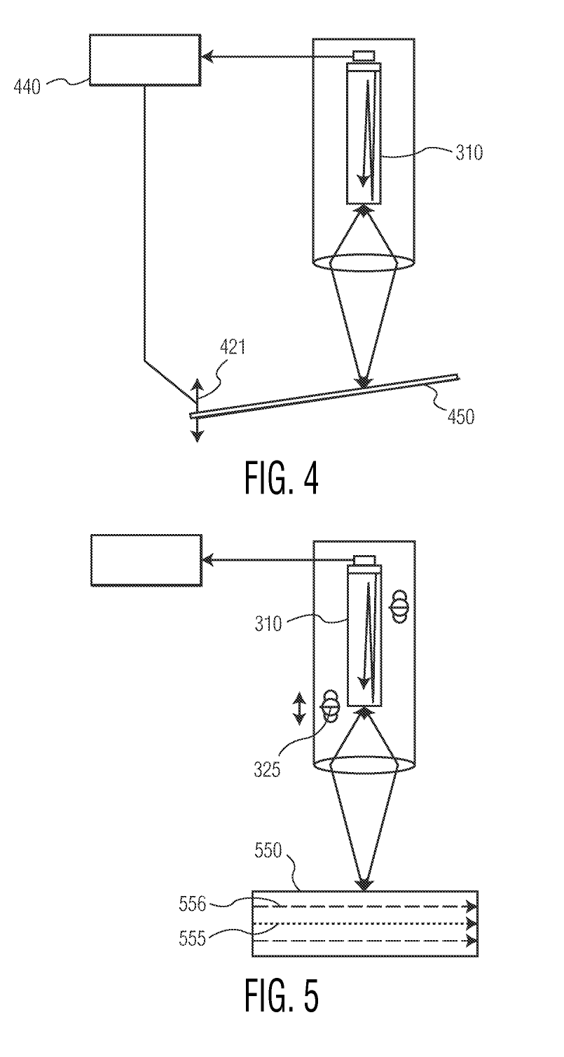

FIG. 4 illustrates the use of a self-coherent detector 310 for controlling the distance between the detector 310 and the location of a surface 450. An actuator 440 controls the location of the surface 450 relative to the detector 310, as illustrated by the arrow 421. As would be apparent to one of ordinary skill in the art, the actuator 440 could effect the same adjustment of the location of the surface 450 relative to the detector 310 by moving the detector 310.

U.S. Pat. No. 6,759,671, “METHOD OF MEASURING THE MOVEMENT OF A MATERIAL SHEET AND OPTICAL SENSOR FOR PERFORMING THE METHOD”, issued 6 Jul. 2004 to Liess et al., and incorporated by reference herein, teaches the use of an optical detector to control the paper transport mechanism of a printer to assure proper transport speed, control skew, detect jams, and so on. In a complementary application, U.S. Pat. No. 5,808,746, “PHOTODETECTOR APPARATUS”, issued 15 Sep. 1998 to Koishi et al., and incorporated by reference herein, the relative location of the optical detector is adjusted based on signals received by the optical detector. By using the self coherent optical detection of the current invention, these known techniques for adjusting the location of an object/surface relative to the detector can be enhanced by providing high-resolution coherent detection, but without the cost and complexity of conventional coherent detection systems that use external reflectors and beamsplitters.

FIG. 5 illustrates the use of a self-coherent detector 310 that is configured to measure fluid flow in a transparent conduit 550. In a preferred embodiment, the conduit 550, or the detector 310, are arranged so that the edge of the conduit 550 is located between the ghost-coherent distances 260 of FIG. 2C, so that neither the edge, nor the turbulence that may occur at the edge, affects the output of the detector 310. In a simple embodiment, the conduit will have a radius that is less than the distance 255 between the ghost-coherent distances 260 of FIG. 2C, and the center of the conduit is located at one of the distances 260. In a larger conduit, multiple ghost-coherent distances 260 may be located within the conduit, each contributing to the detector output signal that is correlated to the fluid flow. With multiple detections and appropriate calibration of the output signal to a proper flow, obstructions that cause non-uniform flow through the conduit may be detected more readily than with conventional non-coherent detectors.

The fine resolution of the coherent detector of FIG. 2C also facilitates distinguishing among flows of a layered fluid, such as a fluid that may include a thin film layer of oil or water. Depending upon the particular application, the ghost-coherent distance of the detector may be set to detect the presence of such a layer and/or its velocity, which may differ substantially from the velocity of the underlying fluid. In another application, the ghost-coherent distance may be set to just below this film, and the proper velocity of the underlying fluid is measured. These and other applications for layer-specific flow determinations will be evident to one of skill in the art in view of this disclosure.

In preferred embodiments of this invention, only the intended target surface is located at the ghost-coherent distance(s), so that the output of the detector 310 corresponds to reflections from the intended target surface. However, one of ordinary skill in the art will also recognize that reflections from other surfaces that may be located at other ghost-reference distances may be canceled/compensated by conventional calibration techniques that establish a baseline from which changes are detected. That is, because the detector 310 of this invention will generally be placed in a ‘static’ environment with objects at relatively fixed distances from each other, an output corresponding to this static environment can be measured, and changes to this environment caused by changes of the target object can be readily detected and reported if the target is located at a ghost-coherent distance 260.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts is intended to be required unless specifically indicated; and

i) the term “plurality of” an element includes two or more of the claimed element, and does not imply any particular range of number of elements; that is, a plurality of elements can be as few as two elements.

1. An optical detector (210, 310) comprising:
a laser diode (114) that is configured to project light,
a cavity (213) that is configured to:
provide internal reflections of the light,
emit a beam of the light, and
receive external reflections of the light, and
a detector (115) that is configured to provide an output signal corresponding to the internal and external reflections, and
a lens system (330) that is configured to provide a focal point (351) at a target distance (260), such that external reflections from the target distance (260) are coherent with one or more of the internal reflections.

2. The optical detector (210, 310) of claim 1, wherein
the lens system (330) includes a depth of field that includes multiple target distances (260), reflections from which distances are also coherent with one or more of the internal reflections.

3. The optical detector (210, 310) of claim 1, including:
a processor (340, 440) that is configured to receive the output signal from the detector (115) and to determine therefrom one or more parameters associated with an intended target.

4. The optical detector (210, 310) of claim 3, wherein
the one or more parameters include at least one of:
a presence of the intended target at the target distance (260),
a movement of the intended target from the target distance (260), and
a velocity of the intended target at the target distance (260).

5. The optical detector (210, 310) of claim 3, including
an actuator (440) that is configured to control placement of the intended target relative to the cavity (213).

6. The optical detector (210, 310) of claim 5, wherein
the actuator (440) is configured to control the placement based on the one or more parameters.

7. The optical detector (210, 310) of claim 1, wherein
the laser diode (114) and cavity (213) are configured to form a superluminescent laser diode (SLD).

8. The optical detector (210, 310) of claim 1, wherein
the cavity (213) includes an exit end through which the beam of light is emitted,
the exit end includes a surface (112) having a reflection coefficient that is below a threshold coefficient that provides a laser mode of emission.

9. The optical detector (210, 310) of claim 8, wherein
the reflection coefficient is within a range of 75-95% of the threshold coefficient.

10. A system comprising:
a support structure (301),
an optical detection device (310), and
a target object (350, 450, 555),
wherein
the optical detection device (310) is configured to be located on the support structure (301) at a target distance (260) from the target object (350, 450, 555), and
the target distance (260) substantially corresponds to one of a plurality of ghost-coherent distances associated with coherent internal reflections within the optical detection device (310).

11. The system of claim 10, including
one or more adjustment devices that are configured to facilitate locating the optical detection device (310) at the target distance (260).

12. The system of claim 10, including
a processor (340, 440) that is configured to receive an output from the optical detection device (310) and to provide therefrom one or more parameters associated with the target object (350, 450, 555).

13. The system of claim 12, wherein
the one or more parameters include at least one of:
a presence of the target object (350, 450, 555) at the target distance (260),
a movement of the target object (350, 450, 555) from the target distance (260), and
a velocity of the target object (350, 450, 555) at the target distance (260).

14. The system of claim 12, wherein
the target object (350, 450, 555) includes a spinning object (350) and the one or more parameters include a rotation speed.

15. The system of claim 12, wherein
the target object (350, 450, 555) includes a media on a transport surface (450), and
the processor (340, 440) is configured to detect a speed of transport of the media.

16. The system of claim 12, wherein
the processor (340, 440) is configured to control a location (421) of the target object (350, 450, 555) relative to the support structure (301).

17. The system of claim 12, wherein
the target object (350, 450, 555) includes a conduit (550), and the one or more parameters include a measure of fluid (555) flow through the conduit.

18. The system of claim 10, including
a lens system (330) that is configured to provide a focus (351) of the optical detection device (310) at the target distance (260).

19. The system of claim 18, wherein
the lens system (330) provides a depth of field that spans a predetermined number of ghost-coherent distances (260, 555, 556).

20. The system of claim 10, wherein
the optical detection device (310) includes a superluminescent laser diode (SLD).

21. The system of claim 20, wherein
the superluminescent laser diode includes a cavity (213) that includes an exit end through which light is emitted,
the exit end includes a surface (112) having a reflection coefficient that is within a range of 75-95% of a threshold coefficient that provides a laser mode of emission.

22. A method of optical detection comprising:
determining one or more ghost-coherent distances (260) from a superluminescent laser diode (210, 310) from which reflections are coherent with internal reflections within a cavity (213) of the superluminescent laser diode (210, 310),
affixing the superluminescent laser diode (210, 310) on a supporting structure (301) such that a target point (351) is coincident with one of the ghost-coherent distances (260), and
determining one or more parameters associated with an object (350, 450, 555) at the target point (351).

23. The method of claim 22, wherein
the one or more parameters include at least one of:
a presence of the object at the target distance (260),
a movement of the object from the target distance (260), and
a velocity of the object at the target distance (260).
